(19) United States
(12) Patent Application Publication
(10) Pub. No.: US 2015/0009691 A1
(43) Pub. Date: Jan. 8, 2015

(54) PROTECTIVE COVER FOR A LAMP FINIAL

(71) Applicant: David Michael Sandoval, Huntington Beach, CA (US)

(72) Inventor: David Michael Sandoval, Huntington Beach, CA (US)

(73) Assignee: Industrial Security Solutions, Corp., Huntington Beach, CA (US)

(21) Appl. No.: 13/936,101

(22) Filed: Jul. 5, 2013

(51) Int. Cl. F21V 15/00; F21V 17/00

(52) U.S. Cl. CPC F21V 15/005; F21V 17/00
USPC 362/433; 29/428; 29/525.01

(57) ABSTRACT

A protective cover adapted to house a lamp finial. The protective cover includes a cavity sized to house a lamp finial, the cavity having an open mouth. At least one tab is coupled to the cavity, preferably coupled to opposing sides of the open mouth of the cavity. An aperture can be disposed on each one of the tabs and a fold line can be disposed between the aperture and the cavity.

### FIELD OF THE INVENTION

The present invention is directed to a protective cover for a lamp finial and to methods for preventing the unauthorized removal or theft of lamp finials from their associated lamps.

### BACKGROUND

Lamps typically terminate in a finial which functions to affix a shade to a lamp base. Finials are typically externally decorative whilst hiding an internal screw thread configured to receive a screw that projects upwardly from a lamp harp. Lamp finials are configured to be easily removable so as to permit replacement or removal of a lamp shade to permit replacement of a light bulb.

Because of their easy removability, lamp finials are vulnerable to being stolen or switched with finials associated with another lamp in a retail setting. For example, a consumer purchasing a lamp may prefer a finial from a different lamp and may swap finials to suit his or her tastes. It is difficult to detect when a lamp finial has been switched or stolen.

Therefore, what is needed is an effective device and method for preventing the unauthorized removal of lamp finials from associated lamps.

### BRIEF SUMMARY

It is understood that the principles underlying the basic configuration of the protective cover for a lamp filial may also have other applications in which it is desired to have a protective an anti-theft cover.

In one embodiment, a protective cover adapted to house a lamp finial is provided. The protective cover comprises a cavity sized to house a lamp finial and at least one tab coupled to the cavity. The cavity comprises an open mouth sized to receive the lamp finial.

In accordance with a first aspect of the embodiment, the cavity is shaped as a dome.

In accordance with a second aspect of the embodiment, the protective cover further comprises a lip disposed along a portion of a periphery of the open mouth.

In accordance with a third aspect of the embodiment, the cavity is made of a transparent material.

In accordance with a fourth aspect of the embodiment, the at least one tab comprises two or more tabs disposed on opposing sides of the cavity.

In accordance with a fifth aspect of the embodiment, the protective cover further comprises a fold line disposed adjacent to or on the at least one tab.

In accordance with a sixth aspect of the embodiment, the protective cover further comprises an aperture disposed on the at least one tab.

In accordance with a seventh aspect of the embodiment, the protective cover further comprises ties configured to be threaded through the apertures.

In another embodiment, a method for preventing theft of a lamp finial from a lamp is provided. The method comprises at least partially enclosing the lamp finial with a covering, the covering comprising an open mouth and tabs disposed adjacent the open mouth and securely coupling the tabs to the lamp.

In accordance with a first aspect of the embodiment, the method further comprises folding the tabs downwardly along a fold line disposed adjacent to or on the tabs.

In accordance with a second aspect of the embodiment, the tabs are each securely coupled to a harp of the lamp, the harp extending from opposing sides of the lamp finial.

In accordance with a third aspect of the embodiment, the step of securely coupling comprises providing an aperture on each one of the tabs and coupling each one of the tabs to the harp of the lamp on opposing sides of the lamp finial by securing each tab with a tie threaded through the aperture and affixed around the harp.

In a further embodiment, an assembly for preventing theft of a lamp finial from an associated lamp is provided. The assembly comprises a lamp comprising a finial and a harp extending from the finial, a protective cover adapted to at least partially house the finial, and ties. The protective cover comprises tabs, each one of the tabs comprising an aperture and configured to couple with the harp. The ties configured to be threaded through the apertures and to couple the protective cover to the harp.

In accordance with a first aspect of the embodiment, the cavity is shaped as a dome.

In accordance with a second aspect of the embodiment, the cavity is made of a transparent material.

In accordance with a third aspect of the embodiment, the assembly further comprises a lip disposed along a portion of a periphery of the open mouth.

In accordance with a fourth aspect of the embodiment, the assembly further comprises a fold line disposed between the aperture and the cavity.

In accordance with a fifth aspect of the embodiment, the fold line is perforated.

In accordance with a sixth aspect of the embodiment, the harp comprises at least two legs on opposing sides of the finial.

In accordance with a seventh aspect of the embodiment, the tabs are disposed on opposing sides of the protective cover corresponding to the legs on opposing sides of the finial when the protective cover is positioned to house the finial.

Other objects, features and advantages of the described preferred embodiments will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

Preferred and non-limiting embodiments of the inventions may be more readily understood by referring to the accompanying drawings in which:

FIG. 1 is a perspective view of an embodiment of the removable lamp finial cover;

FIG. 2 is a front elevation view of the lamp finial cover of FIG. 1, with the rear elevation view being identical to the front elevation view;

FIG. 3 is side elevation view of the lamp finial cover of FIG. 1, with the other side elevation view being identical;

FIG. 4 is a top plan view of the lamp finial cover of FIG. 1;

FIG. 5 is a bottom plan view of the lamp finial cover of FIG. 1; and

FIG. 6 shows the assembly of the lamp finial cover and a lamp.

Like numerals refer to like parts throughout the several views of the drawings.

### DETAILED DESCRIPTION OF THE PREFERRED EMBODIMENT

Specific, non-limiting embodiments of the present invention will now be described with reference to the drawings. It should be understood that such embodiments are by way of example only and merely illustrative of but a small number of embodiments within the scope of the present invention. Various changes and modifications obvious to one skilled in the art to which the present invention pertains are deemed to be within the spirit, scope and contemplation of the present invention as further defined in the appended claims.

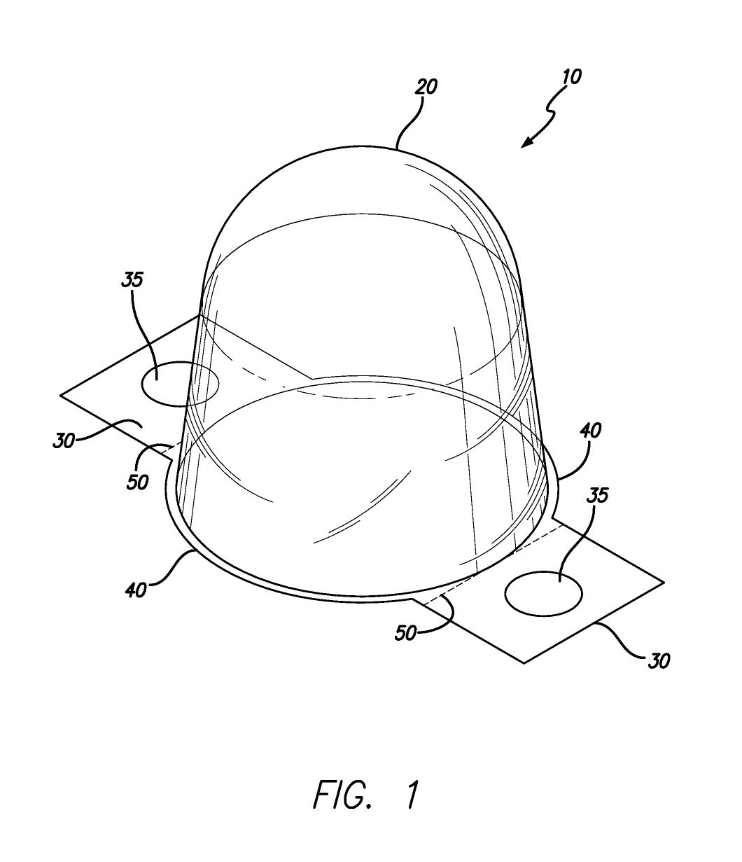

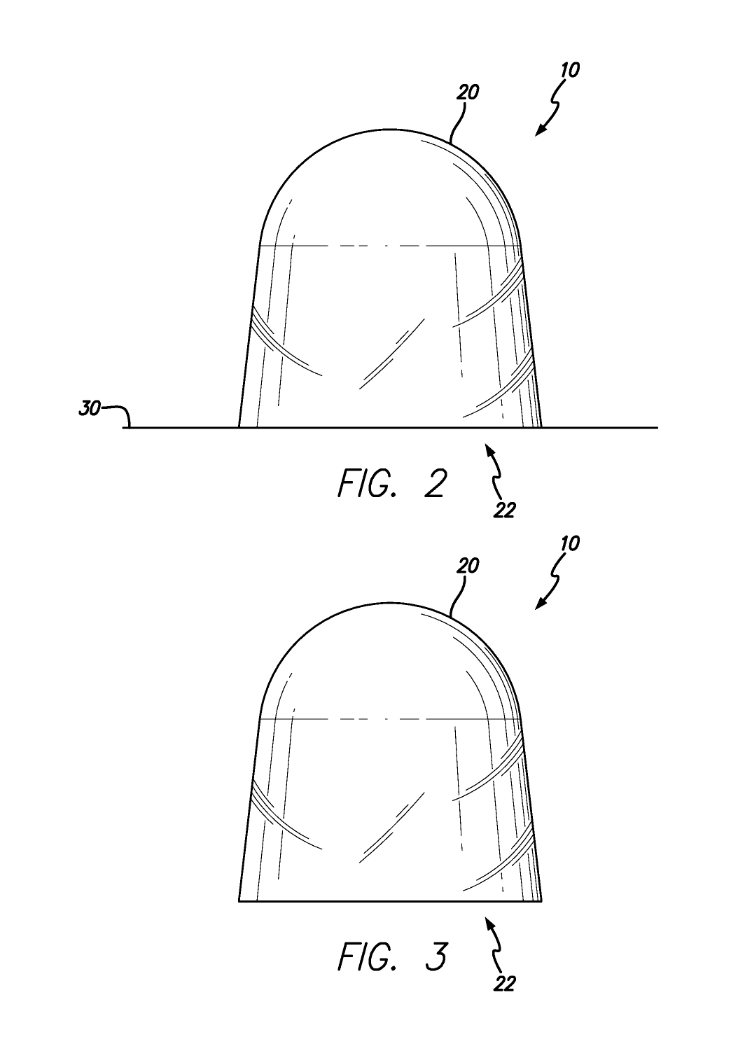

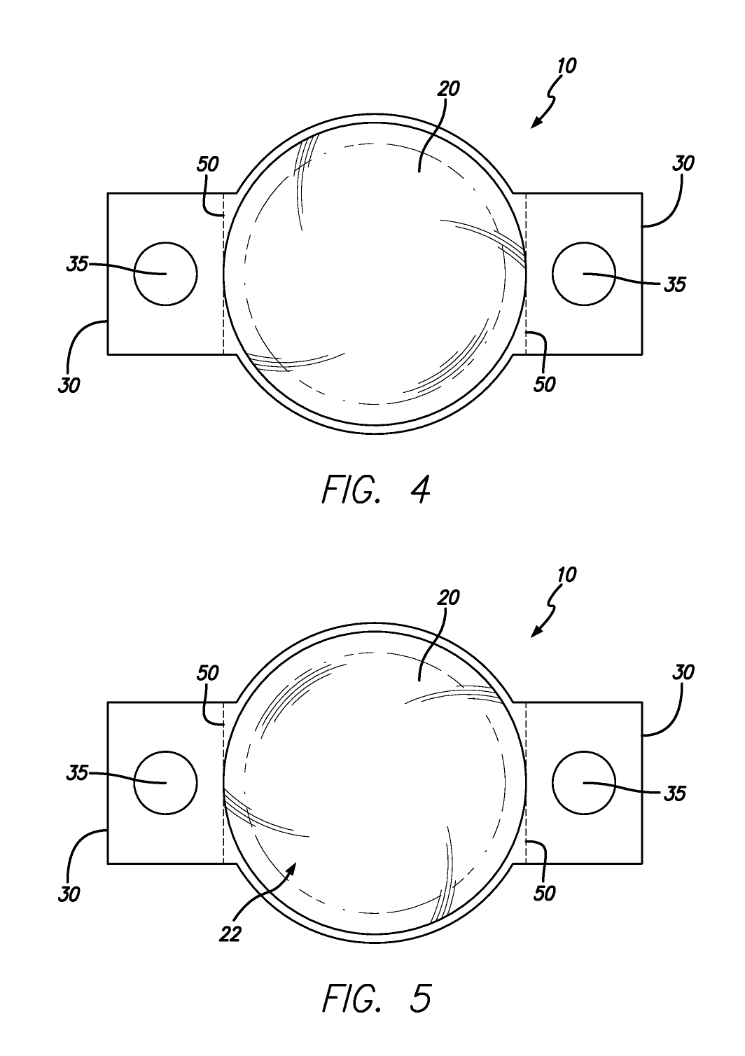

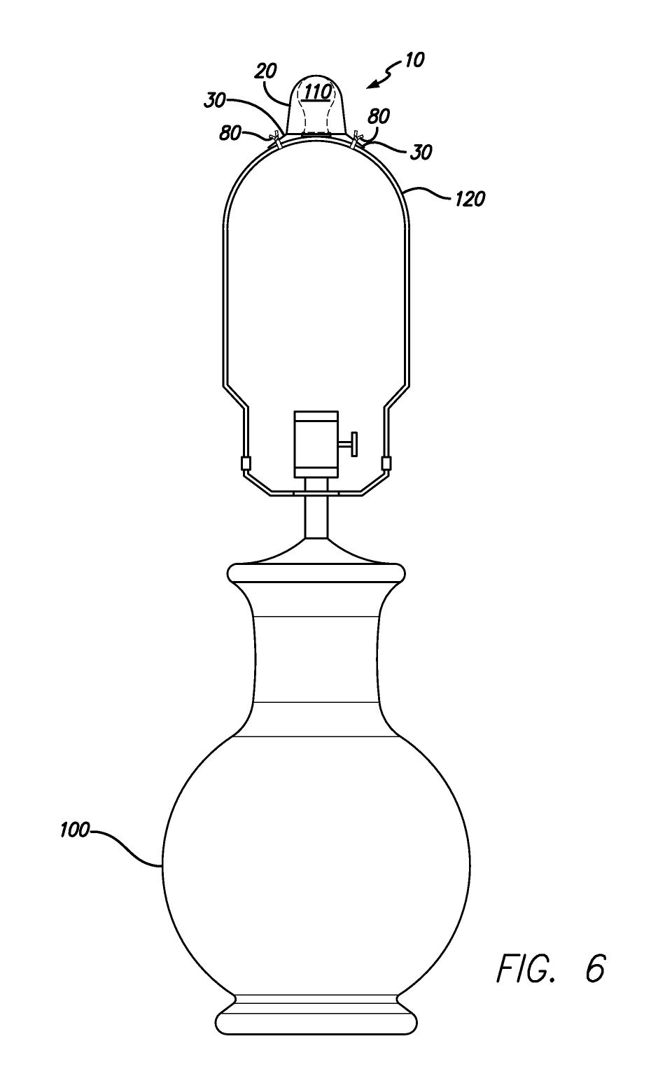

FIGS. 1-5 depict an exemplary embodiment of a lamp finial cover 10 comprising a cavity 20, an open mouth 22 sized to receive a lamp finial and tabs 30 disposed on the sides of the open mouth 22 of the cavity 20. While the cavity 20 is depicted as being dome-shaped, it is understood that the cavity 20 may be configured in any shape and size so long as it is dimensioned to at least partially, and preferably fully, house a lamp finial. Because lamp finials often come in a variety of sizes, the cavity 20 may be provided in a variety of different shapes and sizes. In a preferred embodiment, the cavity 20 is made of a transparent material, such as a clear plastic, so that the lamp finial remains visible in the retail setting when the lamp finial cover 10 is placed thereon. In a preferred embodiment, a peripheral lip 40 surrounds the open mouth 22 of the cavity 20.

Tabs 30 are preferably disposed on opposing sides of the open mouth 22. While FIGS. 1-5 depict two tabs 30 on opposing sides of the open mouth 22, it is understood that more than two tabs may be provided. There are no restrictions as to the size or shape of the tabs 30 so long as the tabs 30 permit attachment of the lamp finial cover 10 to a part of the lamp. To that end, and in a preferred embodiment, tabs 30 further comprise apertures 35 to permit attachment of the lamp finial cover 10 to the lamp by threading ties through the apertures 35 and tying to a part of the lamp (see FIG. 6). A fold line 50 is optionally provided between the open mouth 22 of the cavity 20 and the apertures 35 to permit the tabs 30 to be folded downwardly away from the dome-shaped cavity. In a preferred embodiment, a single fold line 50 may be provided as a groove or a perforated line formed across the width of the tab 30.

FIG. 6 illustrates the lamp finial cover 10 as assembled on a lamp 100. The lamp 100 is depicted as generally comprising a lamp finial 110, a harp 120 and a lower base. The lamp finial 110 typically comprises a threaded aperture (not shown) and is removably coupled to the lamp 100 by a screw (not shown) that projects upwardly from the harp 120. As such, the lamp finial 110 is easily removed by turning and removing it from the screw.

The lamp finial cover 10 is coupled to the lamp 100 via attachment to the harp 120. As can be seen, the cavity 20 of the lamp finial cover 10 fully houses the entire length of the lamp finial 110. Because the walls of the cavity 20 encircling the lamp finial cover 10 are made of a transparent material, the lamp finial 110 remains visible even after the lamp finial cover 10 is placed thereon. As can be seen, the tabs 30 are folded along the fold line in a downward direction and are positioned on opposing sides of the cavity 20 roughly corresponding to the location of the harp 120 on opposing sides of the finial 110.

Ties 80 are threaded through the apertures disposed on the tabs 30 and are looped around and secured to the harp 120. The excess portions of the ties 80 may be cut. In a preferred embodiment, the ties 80 are inexpensive cable ties, zip ties, or tie wraps, typically made of plastic. In a preferred embodiment, the tie 80 comprises two ends, a first one of which comprises a tape section with triangular teeth that slope in one direction and a second one of which comprises a slot with a flexible pawl that irreversibly rides up the slope of the teeth when the tape is inserted. The pawl engages the backside of these teeth to prevent removal of the tape. The excess portions of the tie 80 may be cut after the lamp finial cover 10 is secured to the lamp 100.

The invention described and claimed herein is not to be limited in scope by the specific preferred embodiments disclosed herein, as these embodiments are intended as illustrations of several aspects of the invention. Indeed, various modifications of the invention in addition to those shown and described herein will become apparent to those skilled in the art from the foregoing description. Such modifications are also intended to fall within the scope of the appended claims.

What is claimed is:

1. A protective cover adapted to house a lamp finial comprising:
a cavity sized to house a lamp finial, the cavity comprising an open mouth; and
at least one tab coupled to the cavity.

2. The protective cover of claim 1, wherein the cavity is shaped as a dome.

3. The protective cover of claim 1, further comprising a lip disposed along a portion of a periphery of the open mouth.

4. The protective cover of claim 1, wherein the cavity is made of a transparent material.

5. The protective cover of claim 1, wherein the at least one tab comprises two or more tabs disposed on opposing sides of the cavity.

6. The protective cover of claim 1, further comprising a fold line disposed adjacent to or on the at least one tab.

7. The protective cover of claim 1, further comprising an aperture disposed on the at least one tab.

8. The protective cover of claim 7, further comprising ties configured to be threaded through the apertures.

9. A method for preventing theft of a lamp finial from a lamp comprising:
at least partially enclosing the lamp finial with a covering, the covering comprising an open mouth and tabs disposed adjacent the open mouth; and
securely coupling the tabs to the lamp.

10. The method of claim 9, further comprising folding the tabs downwardly along a fold line disposed adjacent to or on the tabs.

11. The method of claim 10, wherein the step of securely coupling comprises securely coupling the tabs to a harp of the lamp, the harp extending from opposing sides of the lamp finial.

12. The method of claim 11, wherein the step of securely coupling comprises providing an aperture on each one of the tabs and coupling each one of the tabs to the harp of the lamp on opposing sides of the lamp finial by securing each tab with a tie threaded through the aperture and affixed around the harp.

13. An assembly for preventing theft of a lamp finial from an associated lamp, the assembly comprising:
a lamp comprising a finial and a harp extending from the finial;
a protective cover adapted to at least partially house the finial, the protective cover comprising a plurality of tabs, each one of the tabs comprising an aperture; and
a plurality of ties configured to be threaded through the apertures to couple the protective cover to the harp.

14. The assembly cover of claim 13, wherein the cavity is shaped as a dome.

15. The assembly of claim 13, wherein the cavity is made of a transparent material.

16. The assembly of claim 13, further comprising a lip disposed along a portion of a periphery of the open mouth.

17. The assembly of claim 13, further comprising a fold line disposed between the aperture and the cavity on each one of the tabs.

18. The assembly of claim 17, wherein the fold line is perforated.

19. The assembly of claim 13, wherein the harp comprises at least two legs on opposing sides of the finial.

20. The assembly of claim 19, wherein the tabs are disposed on opposing sides of the protective cover corresponding to the legs on opposing sides of the finial when the protective cover is positioned to house the finial.
